(19) United States
(12) Patent Application Publication
(10) Pub. No.: US 2019/0270839 A1
(43) Pub. Date: Sep. 5, 2019

(54) PREPARATION OF RETORT PACKAGING INK THROUGH INCORPORATION OF POLYETHYLENE GLYCOL INTO POLYURETHANE RESINS

(71) Applicant: BASF SE, Ludwigshafen (DE)

(72) Inventors: Alexis BLEVINS, Woodhaven, MI (US); Syed MAHDI, Southfield, MI (US); Steven ZIJLSTRA, Zwolle (NL); Martin BEK, Sint Nicolaasga (NL)

(73) Assignee: BASF SE, Ludwigshafen (DE)

(21) Appl. No.: 16/344,998

(22) PCT Filed: Oct. 27, 2017
(86) PCT No.: PCT/US2017/058666

§ 371 Date: Apr. 25, 2019

Related U.S. Application Data
(60) Provisional application No. 62/414,618, filed on Oct. 28, 2016.
(60) Provisional application No. 62/432,004, filed on Dec. 9, 2016.

(51) Int. Cl. C08G 18/48; C09D 11/102; C08G 18/12; C08G 18/75; B65D 75/26; B65D 65/40; B32B 27/40

(52) U.S. Cl. CPC C08G 18/4833; C09D 11/102; C08G 18/12; C08G 18/4808; C08G 18/4854; B32B 2439/40; B65D 75/26; B65D 65/40; B32B 27/40; B32B 2307/75; C08G 18/755

(57) ABSTRACT

A method of preparing a retort packaging article includes: includes applying an ink to an outer surface of a sealable packaging and overlaying a substantially transparent lamination layer over the ink to envelope at least a portion of the sealable packaging. The ink includes a binder that includes a polyurethane resin that contains an elastomer which is a reaction product of a polyol and polyalkylene glycol with an isocyanate. The elastomer may be chain extended with a diamine or a diol.

### CROSS-REFERENCE TO RELATED APPLICATIONS

This application claims the benefit of priority to U.S. Provisional Application No. 62/414,618, filed on Oct. 28, 2016, and to U.S. Provisional Application No. 62/432,004, filed on Dec. 9, 2016. The contents of each application are incorporated herein by reference in their entirety.

### FIELD

The present technology is generally related to methods of preparing a retort packaging ink applied to a pouch and/or a laminate, and a retort packaging containing an indicia containing an ink that includes a polyurethane resin with a polyalkylene glycol incorporated therein.

### BACKGROUND

Retort packaging is a type of packaging that is constructed from a laminate of flexible plastic and metal foils. It is used for the sterile packaging of a wide variety of food or drink items as well as medical apparatuses.

In a solvent-based film to film lamination system, graphics are typically reverse-printed onto one of the films and then are joined to another film using an adhesive. A typical structure often consists of a top film and a bottom film between which are sandwiched a color ink layer, a white ink layer, and an adhesive layer, usually having this order from top to bottom. Graphics are usually printed onto the top film and the bottom film often acts as a sealant. Typical films utilized are polyethylene terephthalate (PET), oriented polypropylene (OPP), oriented polyamide (OPA), or polyethylene (PE) but are not limited to only those as many others such as metallic films can also be used. The adhesives employed are typically two-part 100% solids systems or solvent-borne polyurethane adhesives.

Printed graphics in the retort system typically represent a weak point in the laminate in terms of lamination bond strength as measured by a peel test. The inks used in these types of systems are typically polyurethane binders combined with pigment dispersions prepared in either a polyurethane resin or nitro cellulose. Lamination systems are tested utilizing a color ink with an adhesive, a white ink with an adhesive, and then a color ink backed with a white ink which is then coated with an adhesive. For an ink system to be considered acceptable it must perform well in all three tests. Furthermore, for high performance applications, the ink must maintain high lamination bond strengths after retort conditions. Retort conditions are typically 131° C. for 40 minutes which allows food inside of packaging to either be cooked or the package to be sterilized.

A limitation of current retort packaging and methods of preparation of the packaging is the decreased lamination bond strength after the packaging material undergoes retort conditions. Specifically, typical film to film lamination systems containing elastomeric polyurethane resins show decreased lamination bond strength after the material is subjected to retort conditions.

### SUMMARY

In one aspect, a method is provided for preparing a retort packaging article. The method includes applying an ink to an outer surface of a sealable packaging and overlaying a substantially transparent lamination layer over the ink to envelope at least a portion of the sealable packaging. The ink includes a binder that includes a polyurethane that contains an elastomer which is a reaction product of a polyol and polyalkylene glycol with an isocyanate. The elastomer may be chain extended with a diamine or a diol to achieve a molecular weight of about 5000 to about 40,000 g/mol.

In another aspect, a method is provided for preparing a retort packaging article. The method includes applying an ink to an inner surface of a substantially transparent lamination layer in a reverse printing orientation to form a printed laminate and applying the printed laminate to and enveloping at least a portion of a sealable packaging. The ink includes a binder that includes a polyurethane that contains an elastomer which is a reaction product of a polyol and polyalkylene glycol with an isocyanate. The elastomer may be chain extended with a diamine or a diol to achieve a molecular weight of about 5000 to about 40,000 g/mol.

In another aspect, provided herein is a retort packaging that includes a sealable foil-based packaging substrate having an inner and outer surface; a laminate overlay having an inner face and an outer face, the inner face being proximal to the sealable foil-based packaging substrate; and an indicia disposed between the sealable foil-based packaging substrate and the laminate overlay. The indicia includes a polyurethane that is a reaction product of a polyol and polyalkylene glycol with an isocyanate. The polyurethane may be chain extended with a diamine or a diol to achieve a molecular weight of about 5000 to about 40,000 g/mol. The retort packaging may exhibit a peel strength of the laminate overlay from the foil-based packaging substrate of greater than 500 g/inch.

### BRIEF DESCRIPTION OF THE DRAWINGS

FIG. 1 is a graphical depiction comparing the lamination bond strengths of polymers of different chemistries with a polyethylene glycol-incorporated polyurethane.

FIGS. 2A-2B are graphical depictions comparing the lamination bond strengths of inks containing different polymers with an ink containing a polyethylene glycol-incorporated polyurethane.

FIG. 3 is a graphical depiction comparing the lamination bond strength of standard amine-terminated polyurethane resin with a polyethylene glycol-incorporated polyurethane.

FIG. 4 is a graphical depiction comparing the printability and color development of inks containing different polymers with an ink containing a polyethylene glycol-incorporated polyurethane.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As set forth herein, it has surprisingly been discovered that the use of a polyalkylene glycol-incorporated polyurethane as an ink in a retort packaging article significantly increases the lamination bond strength of the ink over standard urethane-based inks (i.e. those that do not incorporate a polyalkylene glycol moiety). This allows for the manufacture and use of higher performance flexible packagings. The polyalkylene glycol-incorporated polyurethane inks also maintain the increased lamination bond strength even after the packaging is subjected to retort processing. In addition to increased lamination bond strength, the polyalkylene glycol-incorporated polyurethane inks also exhibit improved pigment dispersability and printability as compared to standard inks. This discovery was surprising because it was expected that the incorporation of polyalkylene glycols into a polyurethane increases the elastomer's susceptibility to hydrolysis, especially when compared to other polyethers typically used to prepare polyurethanes.

Provided herein are retort packaging articles that exhibit a lamination bond strength of greater than 500 g/inch. According to the various embodiments disclosed herein, the lamination bond strength may be about 500 to about 1,000 g/in. For example, the lamination bond strength may be about 600 to 1,000 g/in., about 700 to about 1,000 g/in., about 650 to 950 g/in., about 600 to 950 g/in., about 600 to 900 g/in., about 650 to 900 g/in., about 700 to 950 g/in., or about 700 to 900 g/in. In some embodiments, the lamination bond strength may be about 700 to 900 g/in.

In one aspect, a method is provided for preparing a retort packaging article. The method includes applying an ink to an outer surface of a sealable packaging and overlaying a substantially transparent lamination layer over the ink to envelope at least a portion of the sealable packaging. The ink includes a binder that includes a polyurethane that contains an elastomer which is a reaction product of a polyol and polyethylene glycol with an isocyanate.

The polyol may include a diol or a triol. The polyol can vary in molecular weight, e.g., from about 60 g/mol to about 10,000 g/mol. In some embodiments, the polyol has a molecular weight of about 2,000 g/mol. Non-limiting examples of the polyol include polytetrahydrofuran diol, polypropylene glycol diol, pentane diol, di-propylene glycol, hexane diol, trimethylolpropane. In some embodiments, the polyol includes polytetrahydrofuran diol. In some embodiments, the polytetrahydrofuran diol has a molecular weight of about 2,000 g/mol.

The polyalkylene glycol may be generally represented as a group of formula:

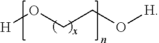

In the formula, each x is individually an integer, and each n is individually an integer. Illustrative values for each individual x include, but are not limited to 0, 1, 2, 3, 4, 5, and 6. The n values merely indicate a polymer repeat unit that may be 1 or 2 or extend for tens or hundreds of units to reach a target polymer molecular weight. Illustrative values for each individual n include, but are not limited to any integer including 1 and up to and including 10,000. For example, n may be any integer including 1 and up to and including 9,000; 1 and up to and including 8,000; 1 and up to and including 7,000; 1 and up to and including 6,000; 1 and up to and including 5,000; 1 and up to and including 4,000; 1 and up to and including 3,000; 1 and up to and including 2,000; 1 and up to and including 1,000; or 1 and up to and including 500. Illustrative polyalkylene glycols may include, but are not limited to polymethylene glycol, polyethylene glycol (PEG), polypropylene glycol (PPG), polybutylene glycols (a single isomer thereof or a mixture of isomers) (PBG), polypentylene glycols (a single isomer thereof or a mixture of isomers) (PBG), polyhexylene glycols (mixtures of isomers), or a mixture of any two or more thereof. In some embodiments, the polyalkylene glycol is PEG, PPG, or a mixture of any two or more thereof.

The polyalkylene glycol may vary in molecular weight, e.g., from about 60 g/mol to about 10,000 g/mol. In some embodiments, the polyalkylene glycol has a molecular weight of about 2000 g/mol.

The polyol and polyalkylene glycol can be present in about a 1:1 ratio prior to reacting with the isocyanate.

The isocyanate includes a di-isocyanate and/or a tri-isocyanate. In some embodiments, the polyol and polyethylene glycol may be reacted with a di-isocyanate. In some embodiments, the polyol and polyethylene glycol may be reacted with a tri-isocyanate.

Once the elastomer is prepared by reacting the polyol and polyethylene glycol with the di-isocyanate, the elastomer may be chain extended with a diamine or a diol to achieve a molecular weight of about 5,000 to about 40,000 g/mol. In some embodiments, the elastomer is chain extended to achieve a molecular weight of about 6,000 to about 30,000 g/mol, about 7,000 to about 20,000 g/mol, about 8,000 to about 15,000 g/mol, about 9,000 to about 15,000 g/mol, or about 10,000 to about 15,000 g/mol. In some embodiments, the elastomer is chain extended to achieve a molecular weight of about 13,000 g/mol.

The polyurethane provided herein may exhibit a lamination bond strength of about 500 to about 1,000 g/in. For example, the polyurethane may exhibit a lamination bond strength of about 600 to 1,000 g/in., about 700 to about 1,000 g/in., about 650 to 950 g/in., about 600 to 950 g/in., about 600 to 900 g/in., about 650 to 900 g/in., about 700 to 950 g/in., or about 700 to 900 g/in. In some embodiments, the polyurethane may exhibit a lamination bond strength of about 700 to 900 g/in.

In addition to the polyurethane provided herein, the ink may further include a colorant. In some embodiments, the colorant is an inorganic pigment, an organic pigment, a dye, or a mixture of any two or more such compounds. Non-limiting examples of pigments include bright pigments such as aluminum powder, copper powder, nickel powder, stainless steel powder, chromium powder, micaceous iron oxide, titanium dioxide-coated mica powder, iron oxide-coated mica powder, and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium dioxide (white), titanium yellow, iron red, carbon black, chrome yellow, iron oxide and various calcined pigments. Additionally, extender pigments may be included. Other examples of suitable pigments include, but are not limited to, Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080 and Raven 1060 (commercially available from Columbian Carbon Co.); Rega1400R, Rega1330R, Rega1660R, Mogul L, Black Pearls L, Monarch 700, Monarch 800, Monarch 880, Monarch 900, Monarch 1000, Monarch 1100, Monarch 1300 and Monarch 1400 (commercially available from Cabot Co.); Color Black FW1, Color Black FW2, Color Black FW2V, Color Black 18, Color Black FW200, Color Black S150, Color Black S160, Color Black S170, Printex35, PrintexU, PrintexV, Printex140U, Printex140V, Special Black 6, Special Black 5, Special Black 4A and Special Black 4 (commercially available from Degussa Co.); No. 25, No. 33, No. 40, No. 47, No. 52, No. 900, No. 2300, MCF-88, MA600, MA7, MA8 and MA100 (commercially available from Mitsubishi Chemical Corporation); cyanic color pigment like C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, Pigment Blue 15:4; C.I. Pigment Blue-16, C.I. Pigment Blue-22 and C.I. Pigment Blue-60; magenta color pigment like C.I. Pigment Red-5, C.I. Pigment Red-7, C.I. Pigment Red-12, C.I. Pigment Red-48, C.I. Pigment Red-48:1, C.I. Pigment Red-57, Pigment Red-57:1, C.I. Pigment Red-112, C.I. Pigment Red-122, C.I. Pigment Red-123, C.I. Pigment Red-146, C.I. Pigment Red-168, C.I. Pigment Red-184 and C.I. Pigment Red-202; and yellow color pigment like C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154. Suitable pigments include a wide variety of carbon black, blue, red, yellow, green, violet, and orange pigments.

Non-limiting examples of dyes used in the inks disclosed herein include Solvent Red 24, Solvent Yellow 124, Solvent Blue 35, azobenzene based dyes, and antraquinone based dyes.

The ink may also further include a defoamer to provide the desired foaming characteristics. Suitable defoaming agents include, but are not limited to, Foamaster® S (blend of silica and oil, including mineral oil produced by BASF), Rhodoline® DF 540 (produced by Rhodia), Rhodoline® 635 (produced by Solvay), Foamaster® MO 2170 (produced by BASF), and Foamaster® MO 2190 (produced by BASF).

The ink may also further include an adhesion promoter to improve the adhesion of the ink to the substrate. Suitable adhesion promoters include, but are not limited to, titanium chelates, organosilane, polyacrylic acid, and polymethlacrylic acid.

In some embodiments, the ink may further include at least one of a colorant, defoamer, or adhesion promoter. In some embodiments, the ink may further include at least two of a colorant, defoamer, or adhesion promoter.

In another aspect, a method is provided for preparing a retort packaging article. The method includes applying any of the above inks to an inner surface of a substantially transparent lamination layer in a reverse printing orientation to form a printed laminate and applying the printed laminate to and enveloping at least a portion of a sealable packaging. As noted above, the ink(s) includes a binder that includes a polyurethane that contains an elastomer which is a reaction product of a polyol and polyalkylene glycol with an isocyanate.

In another aspect, provided herein is a method for curing an indicia for a retort packaging article. The method includes providing a retort packaging article and heating the retort packaging article to a temperature and for a time period sufficient to cure an ink disposed on the retort packaging article. The retort packaging article includes a first substrate in the form of a sealable packaging, a substantially transparent lamination layer overlaying at least a portion of the sealable packaging, and any of the inks described herein containing a polyurethane disposed between the substantially transparent lamination layer and the sealable packaging. The polyurethane includes an elastomer that is the reaction product of a polyol and polyalkylene glycol with an isocyanate.

In another aspect, provided herein is a retort packaging article which includes a sealable foil-based packaging substrate having an inner and outer surface; a laminate overlay having an inner face and an outer face, the inner face being proximal to the sealable foil-based packaging substrate; and an indicia between the sealable foil-based packaging substrate and the laminate overlay. The indicia includes a polyurethane comprising the reaction product of a polyol and polyalkylene glycol with an isocyanate. Additionally, the retort packaging article is subjected to a temperature of 100° C. or greater for a time period sufficient to cure the ink.

In some embodiments, the retort packaging article is a laminate. In some embodiments, the retort packaging article is a pouch.

The polyol may include a diol or a triol. The polyol can vary in molecular weight, e.g., from about 60 g/mol to about 10,000 g/mol. In some embodiments, the polyol has a molecular weight of about 2,000 g/mol. Non-limiting examples of the polyol include polytetrahydrofuran diol, polypropylene glycol diol, pentane diol, di-propylene glycol, hexane diol, trimethylolpropane. In some embodiments, the polyol includes polytetrahydrofuran diol. In some embodiments, the polytetrahydrofuran diol has a molecular weight of about 2,000 g/mol.

The polyalkylene glycol may be generally represented as a group of formula:

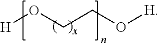

In the formula, each x is individually an integer, and each n is individually an integer. Illustrative values for each individual x include, but are not limited to 0, 1, 2, 3, 4, 5, and 6. The n values merely indicate a polymer repeat unit that may be 1 or 2 or extend for tens or hundreds of units to reach a target polymer molecular weight. Illustrative values for each individual n include, but are not limited to any integer including 1 and up to and including 10,000. For example, n may be any integer including 1 and up to and including 9,000, 1 and up to and including 8,000, 1 and up to and including 7,000, 1 and up to and including 6,000, 1 and up to and including 5,000, 1 and up to and including 4,000, 1 and up to and including 3,000, 1 and up to and including 2,000, 1 and up to and including 1,000, or 1 and up to and including 500. Illustrative polyalkylene glycols may include, but are not limited to polymethylene glycol, polyethylene glycol (PEG), polypropylene glycol (PPG), polybutylene glycols (a single isomer thereof or a mixture of isomers) (PBG), polypentylene glycols (a single isomer thereof or a mixture of isomers) (PBG), polyhexylene glycols (mixtures of isomers), or a mixture of any two or more thereof. In some embodiments, the polyalkylene glycol is PEG, PPG, or a mixture of any two or more thereof.

The polyalkylene glycol may vary in molecular weight, e.g., from about 60 g/mol to about 10,000 g/mol. In some embodiments, the polyethylene glycol has a molecular weight of about 2,000 g/mol.

The polyol and polyethylene glycol can be present in about a 1:1 ratio prior to reacting with the isocyanate.

The isocyanate includes a di-isocyanate and/or a tri-isocyanate. In some embodiments, the polyol and polyethylene glycol may be reacted with a di-isocyanate. In some embodiments, the polyol and polyethylene glycol may be reacted with a tri-isocyanate.

Once the elastomer is prepared by reacting the polyol and polyethylene glycol with the di-isocyanate, the elastomer may be chain extended with a diamine or a diol to achieve a molecular weight of about 5,000 to about 40,000 g/mol. In some embodiments, the elastomer is chain extended to achieve a molecular weight of about 6,000 to about 30,000 g/mol, about 7,000 to about 20,000 g/mol, about 8,000 to about 15,000 g/mol, about 9,000 to about 15,000 g/mol, or about 10,000 to about 15,000 g/mol. In some embodiments, the elastomer is chain extended to achieve a molecular weight of about 13,000 g/mol.

The polyurethane provided herein may exhibit a lamination bond strength of about 500 to about 1,000 g/in. For example, the polyurethane may exhibit a lamination bond strength of about 600 to 1,000 g/in., about 700 to about 1,000 g/in., about 650 to 950 g/in., about 600 to 950 g/in., about 600 to 900 g/in., about 650 to 900 g/in., about 700 to 950 g/in., or about 700 to 900 g/in. In some embodiments, the polyurethane may exhibit a lamination bond strength of about 700 to 900 g/in.

In addition to the polyurethane provided herein, the indicia may further include a colorant. In some embodiments, the colorant is an inorganic pigment, an organic pigment, a dye, or a mixture of any two or more such compounds. Non-limiting examples of pigments include bright pigments such as aluminum powder, copper powder, nickel powder, stainless steel powder, chromium powder, micaceous iron oxide, titanium dioxide-coated mica powder, iron oxide-coated mica powder, and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium dioxide (white), titanium yellow, iron red, carbon black, chrome yellow, iron oxide and various calcined pigments. Additionally, extender pigments may be included. Other examples of suitable pigments include, but are not limited to, Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080 and Raven 1060 (commercially available from Columbian Carbon Co.); Rega1400R, Rega1330R, Rega1660R, Mogul L, Black Pearls L, Monarch 700, Monarch 800, Monarch 880, Monarch 900, Monarch 1000, Monarch 1100, Monarch 1300 and Monarch 1400 (commercially available from Cabot Co.); Color Black FW1, Color Black FW2, Color Black FW2V, Color Black 18, Color Black FW200, Color Black S150, Color Black S160, Color Black S170, Printex35, PrintexU, PrintexV, Printex140U, Printex140V, Special Black 6, Special Black 5, Special Black 4A and Special Black 4 (commercially available from Degussa Co.); No. 25, No. 33, No. 40, No. 47, No. 52, No. 900, No. 2300, MCF-88, MA600, MA7, MA8 and MA100 (commercially available from Mitsubishi Chemical Corporation); cyanic color pigment like C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, Pigment Blue 15:4; C.I. Pigment Blue-16, C.I. Pigment Blue-22 and C.I. Pigment Blue-60; magenta color pigment like C.I. Pigment Red-5, C.I. Pigment Red-7, C.I. Pigment Red-12, C.I. Pigment Red-48, C.I. Pigment Red-48:1, C.I. Pigment Red-57, Pigment Red-57:1, C.I. Pigment Red-112, C.I. Pigment Red-122, C.I. Pigment Red-123, C.I. Pigment Red-146, C.I. Pigment Red-168, C.I. Pigment Red-184 and C.I. Pigment Red-202; and yellow color pigment like C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154. Suitable pigments include a wide variety of carbon black, blue, red, yellow, green, violet, and orange pigments.

The indicia may also further include a defoamer to provide the desired foaming characteristics. Suitable defoaming agents include, but are not limited to, Foamaster® S (blend of silica and oil, including mineral oil produced by BASF), Rhodoline® DF 540 (produced by Rhodia), Rhodoline® 635 (produced by Solvay), Foamaster® MO 2170 (produced by BASF), and Foamaster® MO 2190 (produced by BASF).

The indicia may also further include an adhesion promoter to improve the adhesion of the ink to the substrate. Suitable adhesion promoters include, but are not limited to, titanium chelates, organosilane, polyacrylic acid, and polymethlacrylic acid.

In some embodiments, the indicia may further include at least one of a colorant, defoamer, or adhesion promoter. In some embodiments, the ink may further include at least two of a colorant, defoamer, or adhesion promoter.

In another aspect, provided herein is a retort packaging article that includes a sealable foil-based packaging substrate having an inner and outer surface; a laminate overlay having an inner face and an outer face, the inner face being proximal to the sealable foil-based packaging substrate; and any of the above indicia disposed between the sealable foil-based packaging substrate and the laminate overlay. As noted above, the indicia includes a polyurethane comprising the reaction product of a polyol and polyalkylene glycol with an isocyanate. Additionally, the retort packaging article exhibits a peel strength of the laminate overlay from the foil-based packaging substrate of greater than 500 g/inch.

The retort packaging article exhibits a peel strength of the laminate overlay from the foil-based packaging substrate of greater than 500 g/inch. According to the various embodiments disclosed herein, the peel strength of the laminate overlay from the foil-based packaging substrate may be about 500 to about 1,000 g/in. For example, the peel strength of the laminate overlay from the foil-based packaging substrate may be about 600 to 1,000 g/in., about 700 to about 1,000 g/in., about 650 to 950 g/in., about 600 to 950 g/in., about 600 to 900 g/in., about 650 to 900 g/in., about 700 to 950 g/in., or about 700 to 900 g/in. In some embodiments, the peel strength of the laminate overlay from the foil-based packaging substrate may be about 700 to 900 g/in.

The present embodiments, thus generally described, will be understood more readily by reference to the following examples, which are provided by way of illustration and are not intended to be limiting of the present technology in any way.

### Examples

### Example 1. Preparation of Polyethylene Glycol-Incorporated Polyurethane

Polyurethane elastomers (PUR) are generated through the reaction of a diol with a diisocyanate and then chain extended using either a second diol or a diamine. When a diamine is used, the PUR is in reality a polyurethane/polyurea elastomer but still referred to as a PUR.

A PUR was generated by reacting a 50/50 blend of polytetrahydrofuran diol (pTHF) with polyethylene glycol (PEG), each at 2,000 g/mol, with isophorone diisocyanate to generate a pre-polymer. This pre-polymer was then chain extended with isophorone diamine to generate a PUR at approximately 13,000 g/mol. This reaction can be seen in Scheme 1.

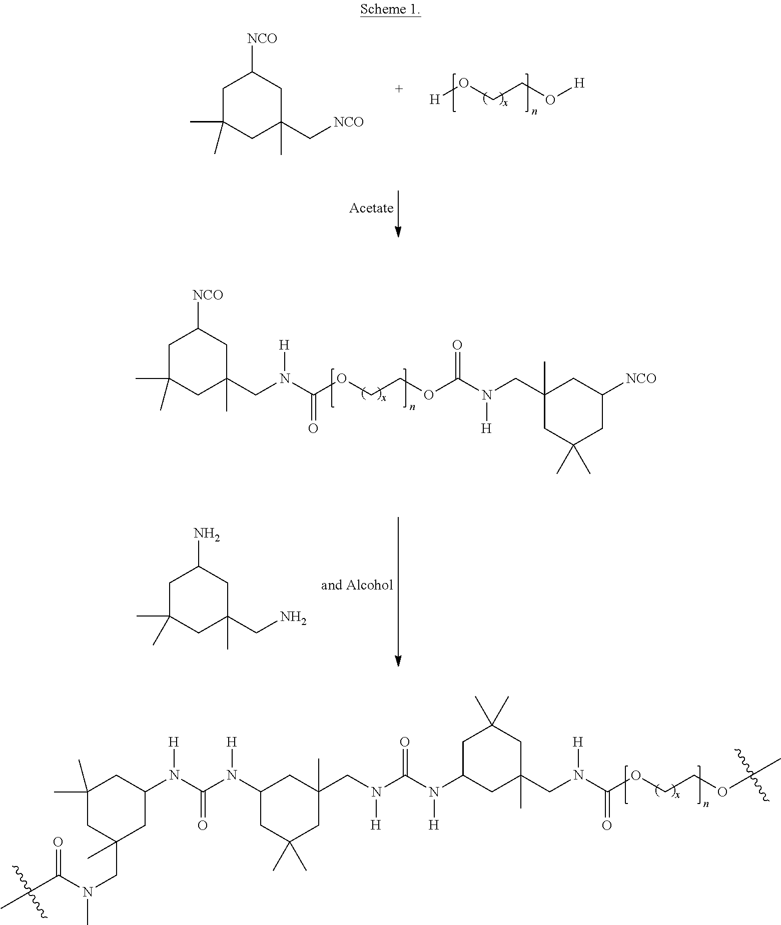

In Scheme 1, each x is individually an integer, and each n is individually an integer. Illustrative values for each individual x include, but are not limited to 0, 1, 2, 3, 4, 5, and 6. The n values merely indicate a polymer repeat unit that may be 1 or 2 or extend for tens or hundreds of units to reach a target overall polymer weight. Illustrative values for each individual n include, but are not limited to any integer including 1 and up to and including 10,000. For example, n may be any integer including 1 and up to and including 9,000, 1 and up to and including 8,000, 1 and up to and including 7,000, 1 and up to and including 6,000, 1 and up to and including 5,000, 1 and up to and including 4,000, 1 and up to and including 3,000, 1 and up to and including 2,000, 1 and up to and including 1,000, or 1 and up to and including 500. Accordingly, in Scheme 1, each length of the polyglycol group within the polymer backbone may be different and there may be variable changes throughout the backbone. The polyglycol may be a polyethylene glycol, a polypropylene glycol, a polybutylene glycol, and the like, and groups may be repeated numerous times in any given segment. In this experiment, the acetate used was butyl acetate and the alcohol used was n-propanol. However, any acetate and any alcohol combination can be used to prepare the polyethylene glycol-incorporated polyurethane disclosed herein.

### Example 2. Lamination Bond Strength of Polyethylene Glycol-Incorporated Polyurethane

One of the major evaluations of the PUR is to test the lamination bond strength when it is used in an ink and reverse printed on a substrate. Adhesion to substrates of the PUR is typically accomplished through physical bonding but not chemically bonded. Aspects of the monomer choices can drastically impact the adhesion of the PUR to the substrate and the cohesion of the PUR with itself and with the pigment system used. Bonding and non-bonding forces can be used to increase the adhesion of the PUR. Exemplary bonding forces include ionic, covalent, and metallic. Exemplary non-bonding (intermolecular) forces include ion-dipole interactions, hydrogen-bonding, dipole-dipole interactions, ion-induced dipole interactions, dipole-induced dipole interactions, and dispersions.

Different chemistries were evaluated in a lamination bond strength test which required the sample to be made into an ink and then used in a laminate. A laminate structure was constructed where two plastic substrates were joined using an adhesive with the printing encapsulated within the laminate. The bond strength was tested by pulling the laminated structure apart utilizing an Instron and recording the force required and noting any applicable observations.

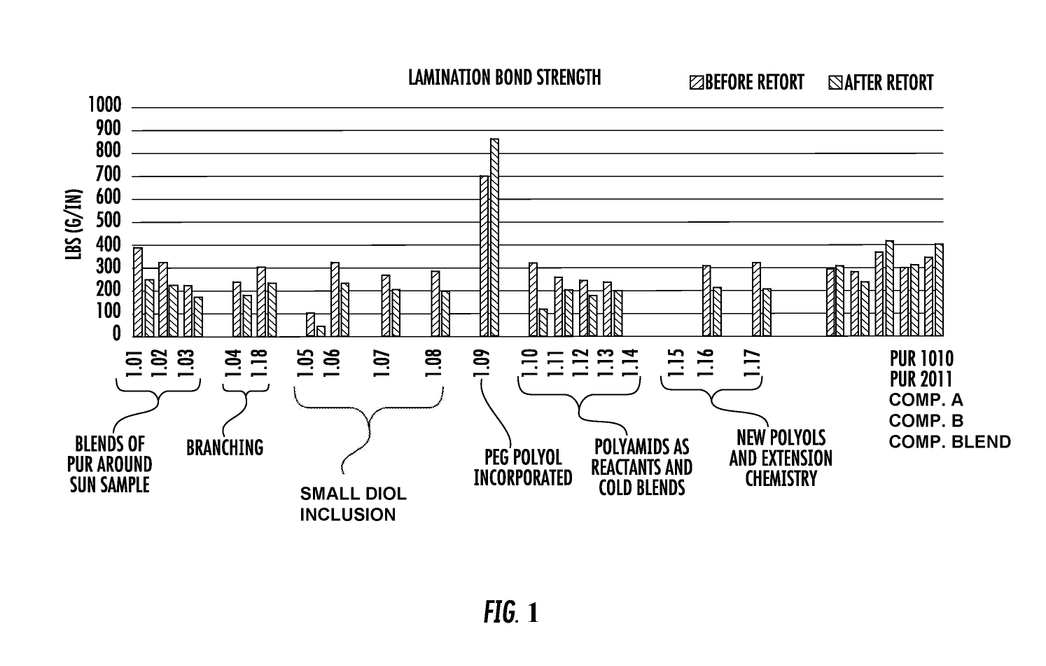

In addition to lamination bond strength of room temperature lamination samples, the bond strength was also tested for samples that had been subjected to a retort process after lamination. To retort a package, the laminated film was subjected to 130° C. above pressurized boiling water for 45 minutes. The sample was then allowed to come back to room temperature and dry before the peel strength was tested. FIG. 1 shows the lamination bond strength with respect to the type of chemistry or changes to the molecular structure. FIG. 1 presents the lamination bond strength in grams force per linear inch but it can also be expressed as Newtons per 15 millimeters. As can be seen in FIG. 1, the PEG-incorporated PUR was the only sample that clearly showed improvement over the standard PUR on the right side of the figure. In the chemistries explored, there were other systems that would increase the hydrogen bonding of the PUR but they did not show the same impact that the inclusion of the PEG demonstrated. It is surprising that the lamination bond strength after retort is so much greater than that of the standard PUR 1011 which uses only pTHF since PEG is more hydroscopic than pTHF.

### Example 3. Lamination Bond Strength and Viscosity of Ink Containing Polyethylene Glycol-Incorporated Polyurethane

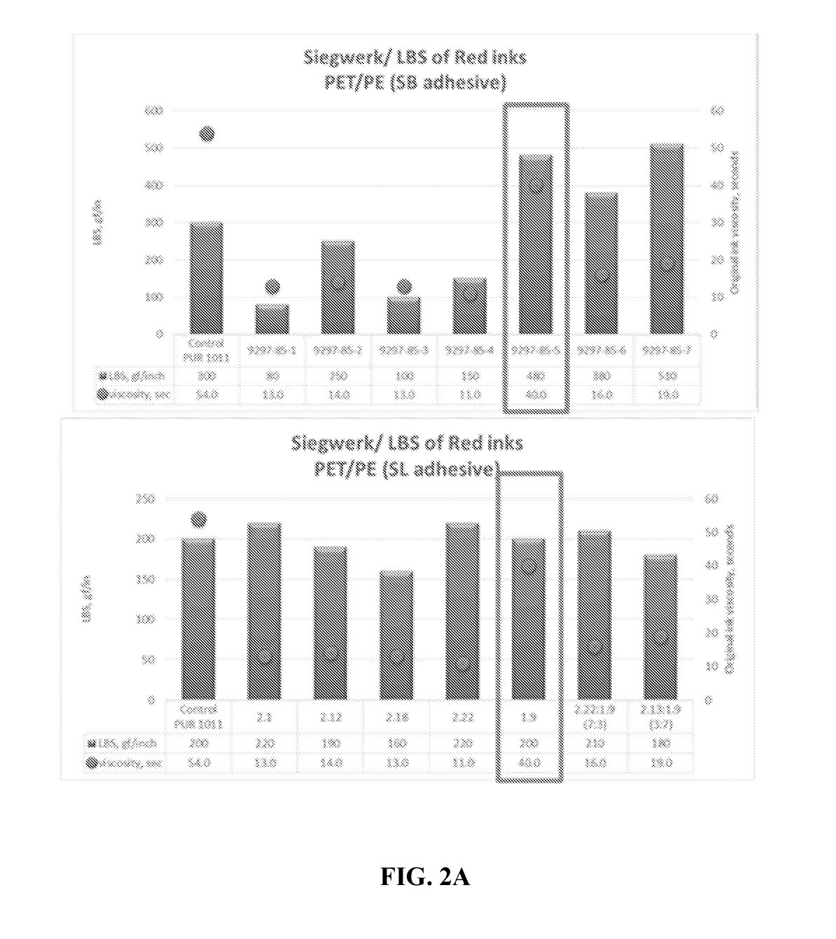

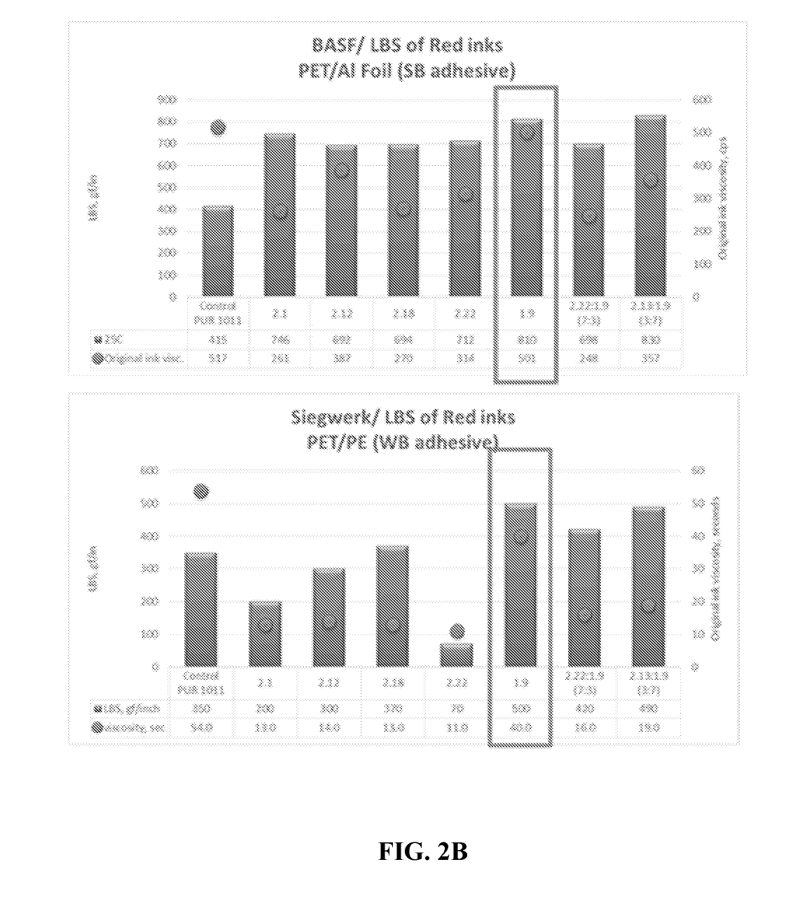

Inks were prepared from the samples of Example 2. As shown in FIGS. 2A-2B, the sample with PEG outperformed all of the other samples on both ink viscosity and lamination bond strength. To make an ink, a pigment was ground in the PUR under stress generated either by a bead mill such as a Lau Paint Shaker or a media mill such as an Eiger mill. A defoamer or adhesion promoter were added across all samples and should thus have equal impact across all samples. Finally the dispersion was filtered and diluted to make the final ink in a targeted viscosity window.

To test dispersions and inks, a standard amount of solvent was added to all dispersions and then the viscosity was measured. FIGS. 2A-2B show the recovered lamination bond strengths (bars) and the resulting ink viscosities (dots) which clearly show that the PEG containing prototype sample, 1.9, has the best combination of lamination bond strength and ink viscosity across different adhesive and substrate combinations. The control, a standard amine-terminated polyurethane resin, is the first bar on the graph. It can be seen through the other samples that while the viscosity of the ink can be decreased, the lamination bond strength typically suffers as a result.

One combination appeared to perform as well as the 1.9 sample but that was a blend of 1.9 with another polymer and it was clearly shown that it did not perform as well as the 1.9 alone in all substrate and adhesive combinations.

### Example 4. Comparison of Lamination Bond Strength of Polyethylene Glycol-Incorporated Polyurethane with Standard PUR

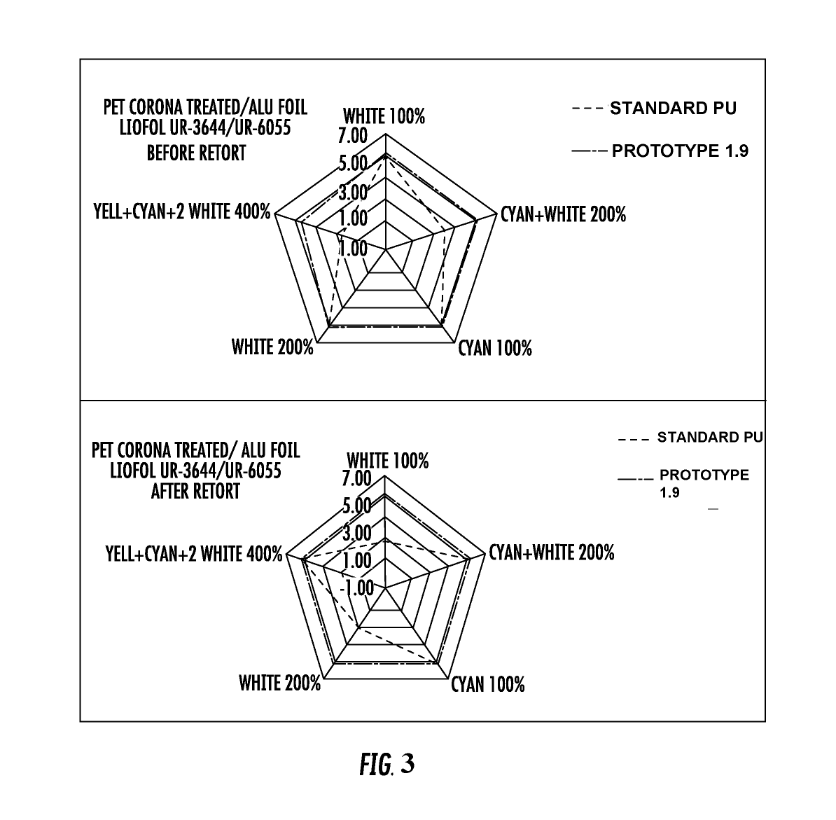

The 1.9 sample of Example 4 was compared to a standard PUR which contains a polyurea functionality as well as a polyurethane functionality. FIG. 3 shows that the 1.9 sample performs as well or better than the standard PUR in multiple different ink systems and amounts of printing. The lamination bond strength of a 100% white ink, a cyan ink over a white ink, 100% cyan ink, two layers of white ink, and a yellow ink followed by cyan ink over two layers of white ink were tested. This provides further support that the PEG-incorporated PUR allows for better lamination bond strength both before and after retort.

### Example 5. Printability and Color Development of Ink Containing Polyethylene Glycol-Incorporated Polyurethane

The last remaining aspects of the ability of the PUR to be a good grind resin and yield a high performance ink system would be to look at the printability and color development of the inks. The color density of an ink is measured to evaluate the color development of an ink, the higher the number the better the pigment has been ground. The driving principle behind color strength is that the strongest color will be developed from pigments that have been ground from agglomerates into their primary particles during the grind process.

As discussed above, a finished ink is typically diluted to the desired viscosity and thus the concentration of perfectly ground pigment particles can be diluted and again the color density would be negatively affected. Based on this, the color strength gives a good indication of both the quality of the pigment grind and the amount of dilution needed to reach the final ink. Related to this would be the ability of the ink to be printed on a printing press without defects in printing such as ink stringing across the substrates or poor transfer from the printing plate.

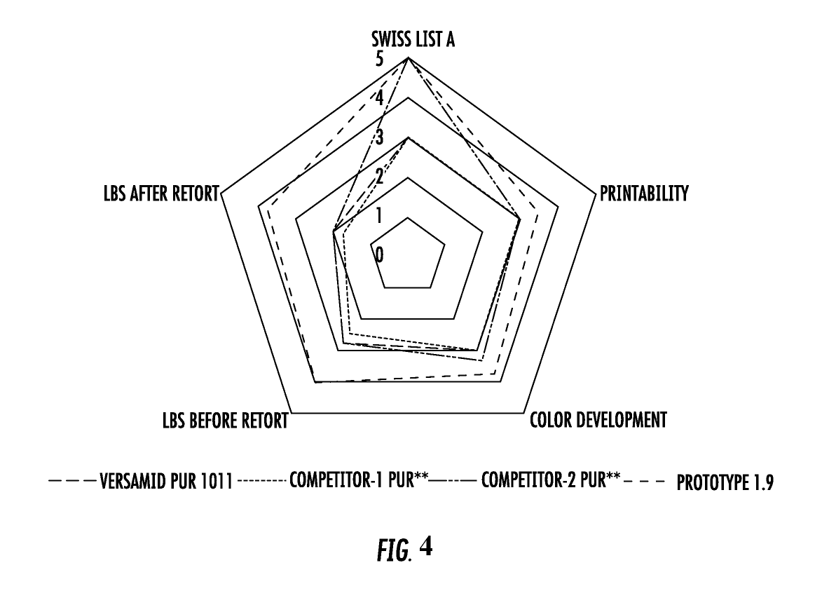

For the PEG-incorporated PUR sample, a printing press trial was conducted where it was observed that the printability of the PEG sample outperformed both the standard amine-terminated polyurethane resin-based ink and two other competitor PUR ink systems where the only variables were the binder resin used. FIG. 4 shows the results from the line trial where it can be seen that the lamination bond strengths previously reported were still observed while the improvement of printability and color development are also observed. Swiss List is also given in FIG. 4 where the PEG prototype is indicated to be better than the standard amine-terminated polyurethane resin but this is due only to the catalyst selected and has no impact on performance.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A method for preparing a retort packaging article, the method comprising:
applying an ink comprising a binder comprising a polyurethane to an outer surface of a sealable packaging; and
overlaying a substantially transparent lamination layer over the ink to envelope at least a portion of the sealable packaging;
or
applying the ink to an inner surface of the substantially transparent lamination layer in a reverse printing orientation to form a printed laminate; and
applying the printed laminate to and enveloping at least a portion of the sealable packaging;
wherein:
the polyurethane comprises:
an elastomer that is the reaction product of a polyol and polyalkylene glycol with an isocyanate.

2. The method of claim 1, wherein the isocyanate comprises a di isocyanate or a tri-isocyanate.

3. The method of claim 1, wherein the elastomer is chain extended with a diamine or a diol to achieve a molecular weight of about 5,000 to about 100,000 g/mol.

4. The method of claim 1, wherein the elastomer is chain extended with a diamine or a diol to achieve a molecular weight of about 13,000 g/mol.

5. The method of claim 1, wherein the polyol and polyalkylene glycol are present in a 1:1 ratio.

6. The method of claim 1, wherein the polyalkylene glycol is a compound of formula: 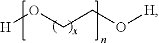
wherein each x is individually an integer from 0 to 6, and each n is individually an integer from 1 to 10,000.

7. The method of claim 1, wherein the polyalkylene glycol comprises polymethylene glycol, polyethylene glycol, polybutylene glycols, polypentylene glycols, polyhexylene glycols, or a mixture of any two or more thereof.

8. The method of claim 1, wherein the polyalkylene glycol is a polyethylene glycol, a polypropylene glycol, or a mixture of any two or more thereof.

9. The method of claim 1, wherein the polyol comprises polytetrahydrofuran diol.

10. The method of claim 1, wherein the ink further comprises an inorganic pigment, an organic pigment, a dye, or a mixture of any two or more thereof.

11. The method of claim 1, wherein the ink further comprises a defoamer.

12. The method of claim 1, wherein the ink further comprises an adhesion promoter.

13. The method of claim 1, wherein the polyurethane exhibits a lamination bond strength of about 500 g/in to about 1000 g/in.

14. The method of claim 10, wherein the polyurethane exhibits a lamination bond strength of about 700 g/in to about 900 g/in.

15. The method of claim 1, wherein the method comprises:
applying the ink to the inner surface of the substantially transparent lamination layer in the reverse printing orientation to form the printed laminate; and
applying the printed laminate to and enveloping at least a portion of the sealable packaging.

16-28. (canceled)

29. A retort packaging comprising:
a sealable foil-based packaging substrate having an inner and outer surface;
a laminate overlay having an inner face and an outer face, the inner face being proximal to the sealable foil-based packaging substrate; and
an indicia disposed between the sealable foil-based packaging substrate and the laminate overlay;
wherein:
the indicia comprises a polyurethane comprising the reaction product of a polyol and polyalkylene glycol with an isocyanate; and
the retort packaging has been subjected to a temperature of 100° C. or greater for a time period sufficient to cure the ink.

30. A retort packaging comprising:
a sealable foil-based packaging substrate having an inner and outer surface;
a laminate overlay having an inner face and an outer face, the inner face being proximal to the sealable foil-based packaging substrate; and
an indicia disposed between the sealable foil-based packaging substrate and the laminate overlay;
wherein:
the indicia comprises a polyurethane comprising the reaction product of a polyol and polyalkylene glycol with an isocyanate; and
the retort packaging exhibits a peel strength of the laminate overlay from the foil-based packaging substrate of greater than 500 g/inch.

31. The method of claim 1, wherein the method comprises:
applying the ink to the outer surface of the sealable packaging; and
overlaying the substantially transparent lamination layer over the ink to envelope at least a portion of the sealable packaging.
